(19) United States
(12) Patent Application Publication
(10) Pub. No.: US 2026/0021487 A1
(43) Pub. Date: Jan. 22, 2026

(54) Positioning Device For Bioprinting

(71) Applicant: New Jersey Institute of Technology, Newark, NJ (US)

(72) Inventors: Elvan Dogan Kumtepe, West Orange, NJ (US); Amir Miri, Summit, NJ (US)

(73) Assignee: New Jersey Institute of Technology, Newark, NJ (US)

(21) Appl. No.: 19/271,186

(22) Filed: Jul. 16, 2025

Related U.S. Application Data
(60) Provisional application No. 63/672,328, filed on Jul. 17, 2024.

(51) Int. Cl. B01L 3/00

(52) U.S. Cl. CPC B01L 3/502761; B01L 2200/027; B01L 2200/0663; B01L 2400/0487

(57) ABSTRACT

A novel portable, and attachable device allows precise positioning of micro-tissues, tumor spheroids, and other biological samples during bioprinting. The device features an interchangeable connector for handling samples of various sizes and uses a manually adjustable pressure system for suction and deposition. A programmable control unit coordinates pressure and positioning based on input commands, enhancing accuracy and consistency in tissue handling. Compatible with multiple bioprinter systems and supporting both manual and automated operation, it streamlines workflows and improves user experience. This device addresses challenges in high-throughput biological positioning, critical for tissue engineering, clinical, pharmaceutical, and research applications. It supports advancements in customized medicine, biological models, and environmental monitoring, meeting the growing demand for precise biologic handling in the multi-billion-dollar bioprinting and biopsy markets. The device offers superior control over tissue biopsy positioning compared to current manual devices reliant on operator skill.

### CROSS-REFERENCE TO RELATED APPLICATIONS

The present application claims the benefit of the filing date of U.S. Provisional Application No. 63/672,328 filed Jul. 17, 2024, the disclosures of which are hereby incorporated herein by reference.

### GOVERNMENT STATEMENT

This invention was made with government support under contract grant number R01DC018577, awarded by the National Institutes of Health (NIH). The government has certain rights in the invention.

### FIELD OF THE DISCLOSURE

The present disclosure generally relates to bioprinting and tissue engineering. In particular, the present disclosure relates to a high-throughput, programmable, positioning device that is portable and designed to position micro tissues and spheroids precisely for bioprinting and tissue engineering applications and contains interchangeable components for added versatility.

### BACKGROUND

Traditionally, tissue engineering has relied on solid, rigid scaffolds made from materials like polyglycolic acid (PGA), combined with isolated cells (Langer and Vacanti, 1993). This approach is based on the idea that placing cells on porous, biodegradable scaffolds in a bioreactor would be enough to generate new organs. However, this method faces several limitations. For one, it is difficult to achieve effective cell penetration and uniform patterning/seeding throughout the scaffold.

Moreover, organs are composed of multiple cell types that need to be precisely positioned-something that is technically challenging with rigid scaffolds. Materials like polylactic acid (PLA), for example, are not well-suited for building contractile tissues such as those found in the heart or blood vessels. Another major issue is the lack of vascularization, which is crucial for delivering nutrients and removing waste in thick tissue constructs.

One attempt to address these issues is seen in U.S. Patent Publication US2015/0375453A1. This reference discloses a system that includes a plurality of dispensers configured to deposit materials from their tips and a printing surface for receiving the materials. The system includes a position sensing detector configured to detect positions of the tip of the dispenser and the location and dimensions of the printing surface. The system also includes a robotic positioning device configured to drive the dispenser and a control unit configured to receive and map in a 3D space the positions of the tip of the dispenser and the position and dimensions of the printing surface. The control unit is further configured to control the robotic positioning device to drive the dispensers relative to the printing surface in the 3D space, and to independently deposit materials on the printing surface, or on material deposited on the printing surface. However, this type of solution lacks portability and restricts use in various settings. Like other bioprinter systems, it cannot be attached to any existing extrusion-based bioprinter, or be upgraded in any way for allowing precise spheroid positioning.

Other researchers to address these challenges have developed cell printing technologies that can create two-dimensional tissue structures. These systems place cell or polymer solutions in specific locations using specialized software. The technique has since evolved to support three-dimensional (3D) printing using biodegradable, thermo-reversible gels. These gels are liquid at around 20° C. and solidify above 32° C., acting like “paper” on which cell aggregates (the “ink”) are printed. By layering gel and cells repeatedly, 3D structures can be built one layer at a time. This method relies on the Differential Adhesion Hypothesis (DAH), which suggests that cells will naturally sort themselves based on their adhesive properties. For instance, cells with stronger adhesion (higher surface tension) tend to move toward the center of a mixed cell cluster, while those with weaker adhesion remain outside. While this self-sorting helps in forming simple structures, such as spheres, it becomes difficult to produce more complex tissue shapes using this technique alone.

Clearly current bioprinting techniques face challenges in precisely positioning micro-tumors, biopsies, tissues, or spheroids. Manual positioning of spheroids can be time-consuming and prone to human error. Either cells or spheroids are encapsulated in hydrogel and printed randomly through nozzle systems, or they are processed using light-based systems in a randomly distributed fashion. Thus, there is still a need in the art for a device that can accurately position micro-tumors, tissues, or spheroids with high precision during bioprinting.

### SUMMARY OF THE INVENTION

The present invention overcomes the drawbacks of previous attempts and provides additional benefits. This invention represents a significant advancement by offering a modular solution that enhances the capabilities of bioprinters. The device is a portable, attachable micro tumor/tissue (spheroid) positioning device that stands out from traditional comprehensive bioprinter systems due to its unique features. It is designed for portability, enhancing flexibility and allowing use in various settings. Unlike complete bioprinter systems, the present device can be attached to any existing extrusion-based bioprinter, providing an economical way to upgrade bioprinting capabilities with precise spheroid positioning. The feature of handheld use adds manual operation flexibility that is useful for tasks that benefit from direct human interaction. In addition, the present invention allows ease of scale up in the process for use in large scale production.

The present device focuses on improving spheroid positioning precision—a critical factor in many applications. Its adaptability, ease of use, and the ability to attach standard syringes or pipet tips make it an invaluable tool. Moreover, when compared with existing handheld bioprinters the inventors found no other devices that matches the vacuum positioning, versatility, and attachment capabilities of the present device for tissue and spheroid positioning.

In accordance with embodiments of the present disclosure, disclosed is a device to position micro tissues and spheroids. In one embodiment, the device could include a main body that provides a structural framework and an interchangeable connector that is sized to receive an interchangeable syringe or pipette tip. The interchangeable connector can receive interchangeable tips of varying sizes to manage different bioprinters, robotic systems, and laboratory workflows. The device could include a pressure control mechanism to selectively apply negative pressure to aspirate samples into the interchangeable syringe and positive pressure to deposit the samples. The device includes a pressure control mechanism capable of selectively applying negative pressure for sample aspiration and positive pressure for sample deposition. The invention is capable of depositing tumor spheroids either without any surrounding liquid (e.g., cell culture media) or with a defined volume of liquid, depending on the selected interchangeable tip type and diameter, providing operational flexibility for various applications. The system enables two operational modes: (i) aspirating and depositing only the solid tissue sample (e.g., a spheroid or organoid) without any surrounding liquid, or (ii) aspirating and depositing the tissue sample along with a defined volume of liquid medium. The operational mode can be selected based on the type of interchangeable tip used.

This flexible functionality enables:
Solid-only transfer, which is advantageous for precise positioning and embedding into engineered environments such as hydrogels (e.g., Matrigel, GelMA) or animal tissue.
Liquid-assisted transfer, which allows rapid handling of biological samples across platforms such as 96-well plates, facilitating applications like combined therapies (e.g., drug and radiation studies) without requiring an extracellular matrix environment.

In one embodiment, the pressure control mechanism could include a pump, such as a diaphragm pump, to generate the negative and positive pressure (relative), and a control unit to regulate pump operation synchronized with positioning movements based on input instructions by the user. The diaphragm pump could be used for both high-throughput and handheld applications. The diaphragm pump enables the device to be used as a micro-pipettor to aspirate and deposit liquid agents and as a manual positioner for micro tissues and spheroids. The pressure control mechanism could include a manual pressure adjustment knob and control buttons to precisely vary the pressure levels.

In another embodiment, the device is sized to precisely pick up individual micro-tissues or spheroids by applying suction through the selected interchangeable tip. Programmable controls and a synchronized positioning system then guide transport and deposition of the aspirated samples at predetermined spatial locations within bio-printed constructs or substrates by regulated release of positive pressure.

Still another embodiment includes a process to position micro tissues and spheroids. Once calibrated with the external bioprinting system, the adjustment knob and the control buttons could be used to apply precise negative pressure through the pump and tubing to pick up the desired biological sample into the tip through suction forces. The controls and synchronized g-code could then guide the device through pre-programmed movements to transport and position the aspirated sample at the specific target location within the bio-printed construct or substrate. Upon reaching this location, positive pressure is applied through the tip to gently deposit the sample in the intended configuration.

In yet another embodiment, the pressure generating mechanism could include a pump that generates both negative and positive pressure, selected from the group consisting of diaphragm pumps, peristaltic pumps, and piston pumps, and a control unit to regulate the pump operation synchronized with positioning movements. The device could include magnetic snaps and tube connectors for secure attachment to existing bioprinters, robotic systems, wherein the device can be utilized as a surgical tool to locally deliver biological agents-loaded systems, such as hydrogel microparticles or hydrogel spheres, either hand-held or with robotic assistance. The negative-positive pressure generating mechanism and control system could enable the device to be used for depositing hydrogels, with hydrogel-loaded syringes depositing through the interchangeable tips onto a desired location, either hand-held or transforming any robotic system into an ink writing or fused deposition bioprinter.

Depending on the implementation, the device may be suitable for use in the food industry, for precise positioning of biological samples, hydrogel encapsulated ingredients, or other biological structures in food processing applications. In one embodiment, the interchangeable tips are configured to manage a range of biological samples, including micro-tissues, spheroids, and hydrogel structures, accommodating various bioprinting, robotic systems, and wet laboratory practices.

The device includes a main body that may be constructed from durable, biocompatible materials, such as, but not limited to, polypropylene (PP), polystyrene (PS), and silicone coating, ensuring suitability for various hand-held and automated applications. The device may also include a power supply system, including batteries for portable operation, with options for AC adapters or solar power extensions for enhanced flexibility in different settings. The control system may also include a microcontroller board and a microprocessor to execute automated routines and synchronize with external bioprinting systems through g-code instructions, a digital interface providing real-time feedback and allowing for precise control over pressure adjustments.

The above objects and advantages are met by the presently disclosed method and apparatus. In addition, the above and yet other objects and advantages of the present invention will become apparent from the hereinafter set forth Brief Description of the Drawings, Detailed Description of the Invention, and claims appended herewith. These features and other features are described and shown in the following drawings and detailed description. Furthermore, any combination and/or permutation of the embodiments are envisioned.

Again, other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

So that those having ordinary skill in the art will have a better understanding of how to make and use the disclosed composition and methods, reference is made to the accompanying figures wherein:

FIGS. 1A-1C are views, side, front and rear views respectively, of a positioning device to position micro tissues, spheroids, and other biological structures, in accordance with one embodiment of the present disclosure;

FIG. 2 illustrates a schematic representation of the adaptation of one embodiment of the present invention into bioprinting and screening process for a tumor spheroid-on-a-chip platform;

FIGS. 3A-3F illustrate one embodiment of a process for spheroid positioning;

FIGS. 4A-4F display panel descriptions that illustrate the tumor spheroid bioprinting process: FIG. 4A illustrates a HT1080 tumor spheroid is centrally located within a microfluidic chip; FIG. 4B illustrates the growth of the spheroid diameter in relation to cell number is shown, which is pertinent for the positioning application using the invention; FIG. 4C illustrates the target precision for spheroid placement within the bioprinted construct is demonstrated; FIGS. 4D-4E illustrate microscopic verification of spheroid placement accuracy on a glass slide is presented, with an average positioning error of 91.095 μm (±62.69 μm), n=6.

FIG. 4F illustrates lower and upper limits of spheroid aspiration based on two different spheroid seeding densities;

FIGS. 5A-5C illustrate results of an experiment observing spheroids during the first five days following the positioning operations.

### DETAILED DESCRIPTION

For purposes of this description, range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 and the like, as well as individual numbers within that range, for example, 1, 2, 2.3, 3, 4, 5, 5.7 and 6. This applies regardless of the breadth of the range.

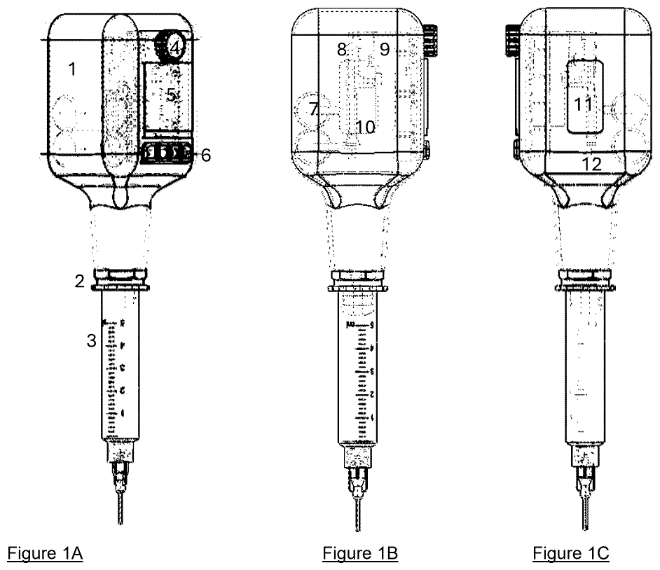

Adverting to the drawings, shown in FIGS. 1A-1C show views of a positioning device to position micro tissues, spheroids, and other biological structures. In one embodiment, the device could include a main body 1 that provides a structural framework and an interchangeable connector 2 that is sized to receive an interchangeable syringe or pipette tip 3. The interchangeable connector 2 can receive interchangeable tips of varying sizes to manage different bioprinters, robotic systems, and laboratory workflows. The modularity enables the device to manage and precisely position biological samples of varying dimensions, from individual cells to larger spheroid structures. The device could include a pressure control mechanism to selectively apply negative pressure to aspirate samples into the interchangeable syringe 3 and positive pressure to deposit the samples.

The following components shown in FIGS. 1A-1C further include knob 4 for pressure adjustment, liquid crystal display (LCD) 5; negative and/or positive pressure and timer control buttons 6; power source 7 such as but not limited to a plurality of 75 Ah batteries; a diaphragm pump 8; a mother board 9 such as but not limited to a mother board or printed circuit board from the manufacturer Raspberry Pi; tubing 10; a magnetic snap 11; and a tube connector 12.

In one embodiment, the pressure control mechanism could include a pump, such as a diaphragm pump 8, to generate the negative and positive pressure, and a control unit to regulate pump operation synchronized with positioning movements based on input instructions by the user. The diaphragm pump 8 could be used for both high-throughput and handheld applications. The diaphragm pump 8 enables the device to be used as a micro-pipettor to aspirate and deposit liquid agents and as a manual positioner for micro tissues and spheroids. It will be understood that the diaphragm pump could be swapped with peristaltic or piston pumps for different pressure profiles, which might be beneficial for handling delicate biologics that require gentler handling to avoid damage. The pressure control mechanism could include a manual pressure adjustment knob 4 and timer control buttons 6 that cooperate with the diaphragm pump 8 to precisely vary the pressure levels.

In one embodiment, the device could include a microcontroller board, such as a LCD screen 5, and a microprocessor or printed circuit board, such as a Raspberry Pi 9. The LCD screen 5 and the printed circuit board or microprocessor 9 facilitate data processing and real-time feedback while working synchronized with generated g-code while positioning. The microprocessor 9 cooperates with the diaphragm pump 8 to execute automated routines when integrated with external bioprinting systems through g-code instructions.

In one embodiment, the device could include batteries 7, such as 75 Ah cells, allowing for portable, untethered operation without reliance on external power sources. This enhances the flexibility to use the device in several laboratory setups. Alternative power modules could include options for AC adapters or solar power extensions for use in field settings or in areas with limited access to reliable electrical power.

The main body 1 could include a magnetic snap 11 and a tube connector 12 to ensure secure attachment of the device to existing bioprinters, robotic systems, or other positioning platforms. The tube connector 12 is connected to the internal tubing 10 to synchronize the pressure control. The diaphragm pump 8 is connected via the tubing 10 and the tube connector 12 to the interchangeable connector 2 and the interchangeable tip 3 to facilitate the positioning of micro tissues and spheroids. It will be understood that other attachment mechanisms could be employed, such as clamp and bracket systems, suction cup mounts, Velcro straps, universal docking stations, slide-and-lock mechanisms, spring-loaded pins, quick-release latches, twist locks, expandable collars, and screw-on adapters.

The main body 1 could be made from durable, biocompatible materials, such as polypropylene (PP), polystyrene (PS), and silicone coating to suit various hand-held applications. The main body 1 features a dual-functionality design, allowing it to be easily attached to a bioprinter via the magnetic snap 11 or utilized as a handheld device for manual applications.

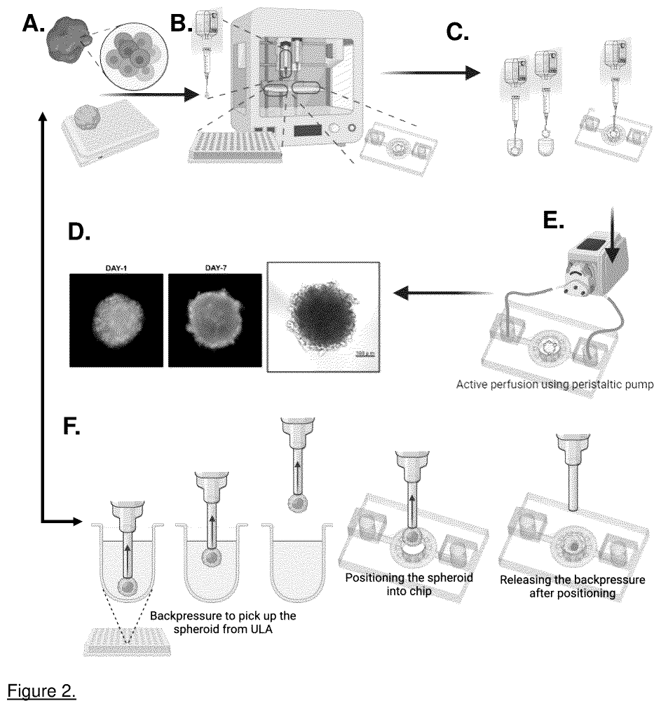

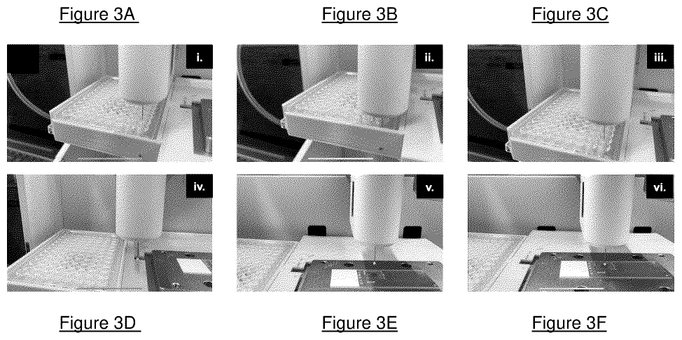

FIG. 2 is a schematic representation of the adaptation of one embodiment of the device into a bioprinting and screening process for a tumor spheroid-on-a-chip platform. The following are representative in FIG. 2. Step (A) tumor spheroids formed in an ultra-low attachment plate; (B) spheroid positioning in a hydrogel chip using the invention attached to a modified bioprinter; (C) detailed view of the spheroid positioning into the bioprinted hydrogel chip; (D) drug screening application involving active perfusion with a peristaltic pump; (E) additional screening applications on tumor spheroids; and (F) detailed view of the spheroid pick-up action, applying and releasing backpressure through the nozzle to precisely position the spheroid at a targeted location. In this embodiment, tumor spheroids are formed in an ultra-low attachment plate. The spheroid is positioned in a hydrogel chip attached to a modified bioprinter. A drug screening application involves active perfusion with a peristaltic pumps. Additional screening applications on tumor spheroids could be performed. The spheroid pick-up action is shown in FIG. 2 step (F) and FIGS. 3A-3F, applying and releasing backpressure through the nozzle to precisely position the spheroid at a targeted location.

FIGS. 3A-3F illustrate one embodiment of a process for spheroid positioning. Individual spheroids are identified for pickup from a 96-well plate via the vacuum nozzle. Negative pressure is applied and timed to coincide with the pickup action. The negative range could range from approximately −3 to −40 kPa, depending on the size of the micro tissue and spheroid. The spheroid is then transported to the target position. The negative pressure is released to accurately place the spheroid. FIGS. 3A-3F, pickup process initiation illustrate the following: (FIGS. 3A-3B) individual spheroids are identified for pickup from a 96-well plate via the vacuum nozzle; (FIG. 3C) the application of negative pressure (depending on the implementation range from approximately −3 to −40 kPa, depending on the size of the micro tissue and spheroid) is timed to coincide with the pickup action. 2; spheroid placement: (FIGS. 3D-3E) the spheroid is then transported to the target position; and (FIG. 3F) the negative pressure is released to accurately place the spheroid.

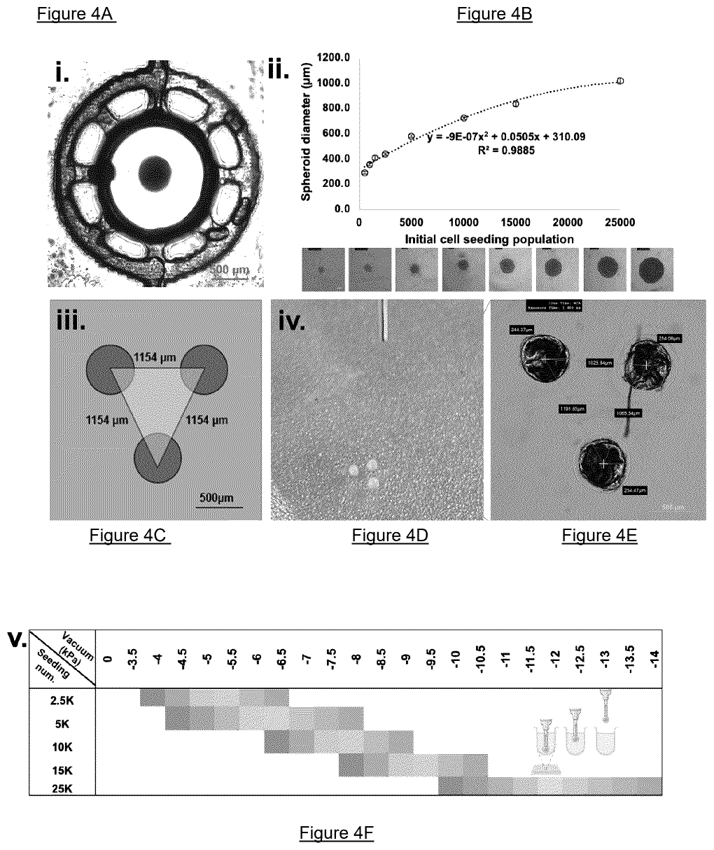

FIG. 4A-4F display panel descriptions that illustrate one embodiment of a tumor spheroid bioprinting process: (FIG. 4A) a HT1080 tumor spheroid is centrally located within a bioprinted microfluidic chip; (FIG. 4B) the growth of the spheroid diameter in relation to cell number is shown, which is pertinent for the positioning application; (FIG. 4C) the target precision for spheroid placement within the bioprinted construct is demonstrated; (FIG. 4D-4E) microscopic verification of spheroid placement accuracy on a glass slide is presented, with an average positioning error of 91.095 μm (±62.69 μm), n=6. It is important to note that the positioning precision is dependent on the bioprinter to which the positioning device is attached. (FIG. 4F) The lower and upper limits of spheroid aspiration are based on two different spheroid seeding densities.

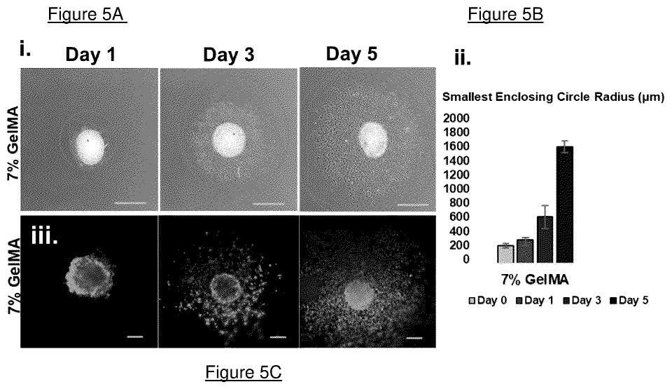

FIGS. 5A-5C presents the results of an experiment observing spheroids during the first five days following the positioning operations. The experiment demonstrates that the cells forming spheroids remain undamaged and retain their physiological state, migrating through the gelatin methacrylate chip and maintaining viability. HT1080 tumor spheroid cell migration and viability within a 7% Gelatin Methacrylate (GelMA) hydrogel matrix. FIGS. 5A-5B show the progressive migration of cells from a spheroid over time (day 1 to day 5), quantified by the smallest enclosing circle radius. FIG. 5C shows fluorescent images demonstrating initial spheroid compactness and subsequent cell migration and spreading.

Depending on the embodiment, the present device could be attached via the magnetic snap 11, with one snap located on either the right or left side of the main body 1 and the other universally designed to mount on any commercially available bioprinter head for high-throughput G-code operations, where positioning precision depends on the bioprinter. Thus, a commercially available bioprinter can be used for regular bioprinting operations as intended, and can also serve as a micro-tissue, spheroid, and biopsy sample positioner within the same operation. The device can also be used in handheld mode, similar to a regular cell culture pipette, where precision depends on the operator's dexterity.

The device could initially be attached to a bioprinter or used manually, depending on the operation mode. Calibration is conducted to synchronize the device with the specific bioprinter's G-code system for precise control through microprocessor 9 integrated into the device.

Spheroids and/or micro-tissues are loaded into the device using interchangeable syringe or pipette tips 3, depending on the size of the media intended for precise placement. Users can position spheroids or micro-tissues either through automated commands that integrate with the bioprinter's operations or manually using the handheld mode through predefined negative pressure. Negative pressure can be adjusted through the knob 4 by user actively before/after or during operation. The device's interface provides real-time feedback and allows adjustments to be made on-the-fly to ensure optimal placement accuracy.

Whether attached to a bioprinter for automated bioprinting tasks or used as a handheld device for more controlled, specific applications, the device offers flexibility and precision. The magnetic snaps 11 and modular design support quick transitions between different operational setups.

The device should first be attached to a bioprinter or any CNC-based robotic device for precise control of positioning through the magnetic snaps 11. At the beginning of a positioning application, the device could be calibrated based on the CNC-controlled device's coordinate system. After generating g-codes for the spheroids to be picked up and positioned, the code starts, and the vacuum and release actions can be synchronized based on the g-code timer. While the appropriate backpressure is maintained, suitable for picking up a specific size of tissue, the device approaches the spheroids and picks them up through the nozzle. As the g-code advances to the desired location, the backpressure remains active. Once the device reaches the target position, the pressure is released, and the spheroid is positioned. This process is highly versatile and suitable for high-throughput applications.

By adhering to this operation sequence, the invention facilitates precise bioprinting and screening processes, contributing to the advanced study of tumor spheroids within a controlled microenvironment. This systematic approach ensures that the formed and positioned spheroids retain their functionality, an essential factor in the reliability of downstream applications such as drug screening and therapeutic development. FIGS. 5A-5C demonstrate that HT1080 tumor spheroid cell migration and viability within a 7% Gelatin Methacrylate (GelMA) hydrogel matrix after positioning process. This figure shows the progressive migration of cells from a spheroid over time, from day 1 to day 5, quantified by the radius of the smallest enclosing circle (FIGS. 5A-5B). Fluorescent images using Calcein-AM and Ethidium homodimer (live-dead stain) display the initial compactness of the spheroid and the subsequent migration and spreading of cells (FIG. 5C). The live-dead ratio varies with photoinitiator (PI) concentrations.

The device could feature modular components that users can reconfigure depending on specific needs. For instance, alternative configurations could include different sizes or shapes of the main body to suit various laboratory spaces or to manage different volumes of biologics.

The device could be designed to integrate additional modules for expanded functionalities, such as built-in microscopic or spectral analysis tools to directly assess the deposition quality and properties of the biologics during the positioning process. Instead of a single knob, a digital interface could be used to allow more precise control over pressure adjustments, or different manual knobs could be used depending on the precision and force required.

The control interface can be made customizable with touch screen capabilities, allowing users to create preset profiles for different spheroid types or experiments, which would streamline the setup process for recurrent tasks. Integration with more advanced g-code generators or CAD software could be developed, enabling more sophisticated design inputs and automation levels.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A portable and attachable device for positioning biological samples, comprising:
(a) a main body configured to be attachable to a bioprinter or bioprinter system;
(b) an interchangeable connector coupled to the main body, the connector being adapted to receive and secure tips of varying sizes for handling biological samples of different dimensions;
(c) an adjustable pressure mechanism operatively connected to the tips, the pressure mechanism configured to apply:
(i) negative pressure for aspirating biological samples into the tips via suction; and
(ii) positive pressure for depositing the biological samples at designated target locations; and
(d) a programmable control unit in communication with the adjustable pressure mechanism and a positioning system, the control unit configured to synchronize pressure application from a built-in pump with spatial positioning movements based on user-defined input instructions for precise positioning of biological samples during a bioprinting process.

2. The device of claim 1, wherein the adjustable pressure mechanism is a pressure generating mechanism selected from the group consisting of diaphragm pumps, peristaltic pumps, piston pumps, and any combination thereof.

3. The device of claim 1, wherein the programmable control unit regulates a pump operation synchronized with positioning movements of the device.

4. The device of claim 1 further includes a plurality of magnetic snaps for attachment to a bioprinter.

5. The device of claim 1, wherein the device is a surgical tool for local delivery of biological agents-loaded systems that includes hydrogel microparticles or hydrogel spheres

6. The device of claim 5, wherein the device is either hand-held or contains robotic assistance.

7. A portable and attachable device for positioning biological samples, comprising:
a main body;
at least one connector on the main body configured to receive an interchangeable tip from a set of tips of varying sizes;
a pressure generating mechanism integrated with the main body, the pressure generating mechanism configured to selectively apply negative pressure to aspirate the biological samples into the tips and positive pressure to deposit the biological samples; and
a control system operatively coupled with the pressure generating mechanism to regulate pressure application.

8. The device of claim 7, wherein the pressure generating mechanism includes a pump for generating both negative and positive pressure, wherein the pump is selected from the group consisting of diaphragm pump, peristaltic pump, piston pumps, and any combination thereof.

9. The device of claim 7, further comprises a plurality of magnetic snaps and tube connectors for attachment to a bioprinter, bioprinter system or robotic system.

10. The device of claim 7, wherein the pressure generating mechanism and control system enable the device for depositing hydrogels with hydrogel-loaded syringes and depositing through the interchangeable tip onto a desired location.

11. The device of claim 10, further includes a robotic system and wherein use of the device with the robotic system transforms the robotic system into an ink writing or fused deposition bioprinter.

12. The device of claim 7, wherein the device is for use in the food industry for precise positioning of biological samples, hydrogel encapsulated ingredients, or biological structures in food processing applications.

13. The device of claim 7, wherein the interchangeable tip is configured to manage a range of biological samples, including micro-tissues, spheroids, and hydrogel structures, and accommodates a plurality of bioprinting, robotic systems, and wet laboratory practices.

14. The device of claim 7, further comprising a power supply system, and wherein the power supply system is selected from the group selected of batteries, alternating current (AC) power supply, solar power, or any combination thereof.

15. The device of claim 7, wherein the control system includes a microcontroller board and a microprocessor to execute automated routines and synchronize with an external bioprinting system through g-code instructions.

16. The device of claim 7, further includes a digital interface for providing real-time feedback and allowing for control over pressure adjustments.

17. A method for positioning of biological samples during a bioprinting process using a portable and attachable device, the method comprising:
(a) attaching a main body of the device to a bioprinter system;
(b) coupling an interchangeable connector to the main body, wherein the connector is adapted to receive and secure a tip selected from a set of tips of varying sizes suitable for handling biological samples of different dimensions;
(c) adjusting a pressure mechanism operatively connected to the secured tip, the pressure mechanism comprising a pump capable of generating both negative and positive pressure;
(d) applying negative pressure through the tip to aspirate biological samples into the tip via suction;
(e) applying positive pressure through the tip to deposit the biological samples at designated target locations;
(f) synchronizing the application of the negative and positive pressures with spatial positioning movements of the device via a programmable control unit; and
(g) wherein the programmable control unit is in communication with both the pressure mechanism and a positioning system, and executes user-defined input instructions to control timing and coordination of pressure and movement.

18. The method of claim 17, further comprises calibrating an external bioprinting system and then using an adjustment knob and control buttons on the device to apply the negative pressure through a pump and tubing to pick up a desired biological sample into the tip through suction forces.

19. The method of claim 18, wherein the negative pressure ranges from approximately −3 kPa to −40 kPa.

20. The method of claim 17, further includes transporting and positioning an aspirated sample at a specific target location within a bio-printed construct or substrate, and upon reaching the specific location applying positive pressure through the tip to deposit the sample in an intended configuration.

21. A portable and attachable device for positioning biological samples, comprising:
a main body configured to be attachable to a bioprinter system;
an interchangeable connector coupled to the main body; the connector configured to receive and secure at least one tip of varying size;
a diaphragm pump integrated within the main body and operatively connected to the connector, the diaphragm pump configured to apply negative pressure to aspirate biological samples into the tip and positive pressure to deposit the biological samples; and
a programmable control unit configured to regulate operation of the diaphragm pump synchronized with positional movements of the main body for controlled delivery of biological samples.
